(19) United States
(12) Patent Application Publication
(10) Pub. No.: US 2003/0054676 A1
(43) Pub. Date: Mar. 20, 2003

(54) Burn-in test socket

(76) Inventors: Hideki Sano, Osaka (JP); Kiyokazu Ikeya, Sunto-gun (JP)

Correspondence Address: Russell E. Baumann, Texas Instruments Incorporated, 34 Forest St., MS 20-21, Attleboro, MA, 02703, US

(21) Appl. No.: 10/227,925

(22) Filed: Aug. 26, 2002

(30) Foreign Application Priority Data
Sep. 11, 2001 (JP) 2001-274552

(51) Int. Cl. H01R 12/00

(52) U.S. Cl. 439/73

(57) ABSTRACT

A socket 1 for testing an electric part 10 has a plurality of contact members 4 which are arranged in the shape of a matrix that are held by a contact holder unit 3 which is secured in a central aperture 6 of socket base 2. The contact holder unit 3 contains a plurality of contact holders 30 which each hold one row of contact members 4 having a thickness equal to the pitch p between neighboring contact members, that are joined together.

### FIELD OF THE INVENTION

This invention relates to a socket for the electrical connection of an electric part to external equipment.

### BACKGROUND OF THE INVENTION

It is common in the art that an integrated circuit (IC) package is prepared by molding an IC chip with an electronic circuit having been formed on its main surface with a resin material. This IC package is then subjected to a reliability test called a “burn-in test” for determining the acceptability of such chip prior to shipping to a customer. In such a burn-in test, a socket is used for the electrical connection between the IC package and the test device.

Such a socket has a plurality of contact pins fixed to the base of the socket for the electrical connection of the terminals of the IC package to the test device. The plurality of contact pins are arranged in such a fashion as to correspond to the terminal arrangement of the IC package.

In a conventional socket, a latch member for fixing an IC package on the IC package receiving part on the base of the socket is provided in such a way as to open and close in linkage with a cover for the socket. The cover moves up and down relative to the base. As the latch is closed, the IC package is pressed downward, so that the terminals of the IC package make electrical contact with the contact members of the socket. It is noted that the IC package described is of the Ball Grid Array (BGA) type where the ball-shaped terminals for connection with the contact members of the socket are arranged in the shape of a matrix.

Among IC packages, there are those whose terminal arrangements are different, even when the outside shapes and dimensions of the packages or the pitches of the terminals are the same. It would be desirable that one kind of socket would take care of these various kinds of IC packages.

To accomplish such an aim in the past, the number of holes provided in the base for fixing the lower part of the contact pins to the base, and simultaneously causing them to protrude as leads from the lower surface of the base have been provided in numbers greater than the number of terminals generally of any one of the IC packages. For any given package, the contact pins are provided into the guide holes and the slits that have been selected in conformity with the terminal arrangement for that IC package. In such cases, however, the guide holes of the base 101 and the slits of the stoppers (not shown in the drawing) have to be provided in large numbers with fine pitches as is shown in FIG. 11. This causes increased complexity to produce the mold and correspondingly the injection molding of the base to cope with such complicated configuration.

In the design of IC packages, there are those in which the terminal arrangement is in the shape of a sequence even-numbered matrix of 2N×2N and others whose in which the terminal arrangement is an odd-numbered matrix of (2N−1)×(2N−1), thereby making it virtually impossible to have one design of socket handle both. Accordingly, it has been necessary to have a base 102 for even-numbered configurations and a base 103 for odd-numbered configurations as are shown in FIGS. 12(a) and 12(b).

The central line axis of the IC packages in the odd-numbered matrix is on the terminal, whereas the central line axis of the IC packages in the even-numbered matrix is between the terminals. Both in the case of the base 102 for the even-numbered matrix and the base 103 for the odd-numbered matrix, the arrangement standard axis of the contact pins and the compression standard axis of the latches are determined with the central line of the base as the standard. As is shown in FIG. 13, therefore, in the case where the IC package 104 of the odd-numbered matrix arrangement, the central line C0 of the IC package is shifted from the central line C1 of the base 102 by a ½ pitch of the contact pin (terminal of the IC package), with a consequence that the latch will not evenly press the IC package on the adaptor. A similar problem also arises in the case where the IC package of the even-numbered matrix has been mounted on the base 103 for the odd-numbered matrix arrangement.

### SUMMARY OF THE INVENTION

Accordingly, it is an object of this invention to provide a socket that holds a large number of contact pins while being easily manufactured, without requiring a high level of mold making expertise or injection molding expertise.

It is another object of this invention to be able to provide just one socket type to handle various kinds of IC packages with different terminal arrangements.

It is yet another object of this invention to be able to provide just one socket type to handle IC packages of an odd-numbered matrix terminals and IC packages with even-numbered matrix terminals.

Briefly, the present invention provides for a socket for mounting an electric part with a plurality of connective terminals comprising a base having a top surface and a bottom surface and a central aperture, a cover mounted on said base so as to be able to move back and forth from a first position away from the top surface of the base to a second position adjacent the top surface of the base, a spring member to bias said cover away from said base, a holding member that accurately holds a plurality of contact members for making contact with said plurality of connective terminals of said electric part, said plurality of contact members are mounted in the holding member in the shape of a matrix and said holding member is secured to said base in the central aperture, an electronic part receiving part for mounting the electronic part in the socket having a plurality of through holes that correspond to said plurality of contact members, said electronic part receiving part being placed adjacent the top surface of said base member overlying said holding member, and a pressing member mounted in said base so as to be able to revolve on said base in conjunction with said cover moving back and forth from a first original position directly adjacent said part receiving part to a second position away from said part receiving part thereby making it possible to mount said electric part in the second position and compressively securing the electronic part in the first original position, where said holding member comprises a plurality of holding parts that hold at least one row of contact members to form the matrix of contact makers and said contact member comprises a base part that is fixed to said holding part, a curved central part capable of elastic deformation within said holding member and a top contact part for being compressively contacted by a connective terminal of the electric part.

### BRIEF DESCRIPTION OF THE DRAWINGS

Other objects, advantages and details of this invention appear in the following detailed description of the preferred embodiments of the invention, the detailed description referring to the drawings in which:

FIG. 1 is a top plan view of a first embodiment of a socket of this invention;

FIG. 2 is a front cross-sectional view of the socket of FIG. 1;

FIG. 3 is a side cross-sectional view of the socket of FIG. 1;

FIG. 4 is a view similar to FIG. 2 with a contact holder unit for the socket being removed;

FIG. 5 is an oblique view the contact holder unit used in the socket of FIG. 1;

FIG. 6 is a side view of a contact in a partial portion of the contact holder of FIG. 5;

FIG. 7(a) is a front view of the positional relationship of contact members in the contact holder of the present invention;

FIG. 7(b) is a side view of the positional relationship of contact members in the contact holder of the present invention;

FIG. 8(a) shows an odd-numbered matrix arrangement of contacts as compared with the central standard of the base and the compression standard of the latch;

FIG. 8(b) shows an even-numbered matrix arrangement of the contacts as compared with the central standard of the base and the compression standard of the latch;

FIG. 9(a) shows the positional relationship between the odd-numbered matrix arrangement of contacts and the odd-numbered matrix terminal structure of an IC package;

FIG. 9(b) shows the positional relationship between the even-numbered matrix arrangement of socket contacts and the even-numbered matrix terminal structure of an IC package;

FIG. 10(a) shows a side view of a contact in a partial portion of a contact holder of a second embodiment of this invention;

FIG. 10(b) shows a side view of a contact holder unit where the contact holders of FIG. 10(a) have been linked;

FIG. 11 shows a top view of a base according to prior art;

FIG. 12(a) shows a top view of a base with an even-numbered row arrangement according to prior art;

FIG. 12(b) shows a top view of a base with an odd-numbered row arrangement according to the prior art; and

FIG. 13 shows the positional relationship between a socket base for conventional even-numbered matrix arrangement and an IC package with an odd-numbered matrix type terminal structure.

### DETAILED DESCRIPTION OF THE PREFERRED EMBODIMENTS

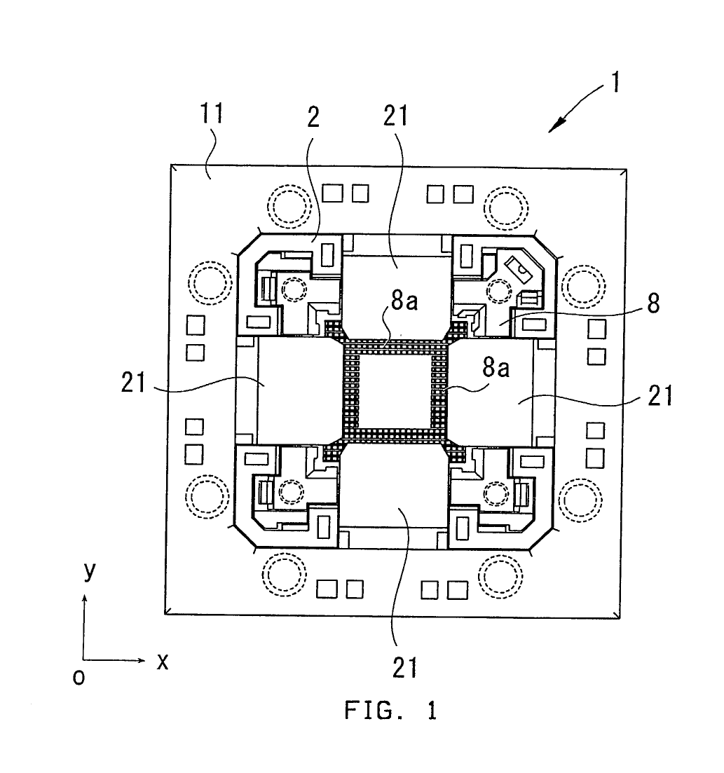

As shown in FIGS. 1 through 3, a socket 1 is provided for mounting an IC package/electronic part 10 of a BGA structure, where the terminals for external connection to socket 1 comprise solder balls arranged in the shape of a matrix on the bottom side at a prescribed pitch p. The socket has a base 2 having a generally rectangular parallelepiped shape having a square section which is larger than the outside shape of IC package 10 to be mounted in socket 1. By using this base as a standard, an x, y and z coordinate system which is shown in the figures will be used to facilitate the explanation of the invention below.

A contact holder unit 3 is provided at the center of the base 2. Contact holder unit 3 is constructed by linking a plurality of contact holders 30 together.

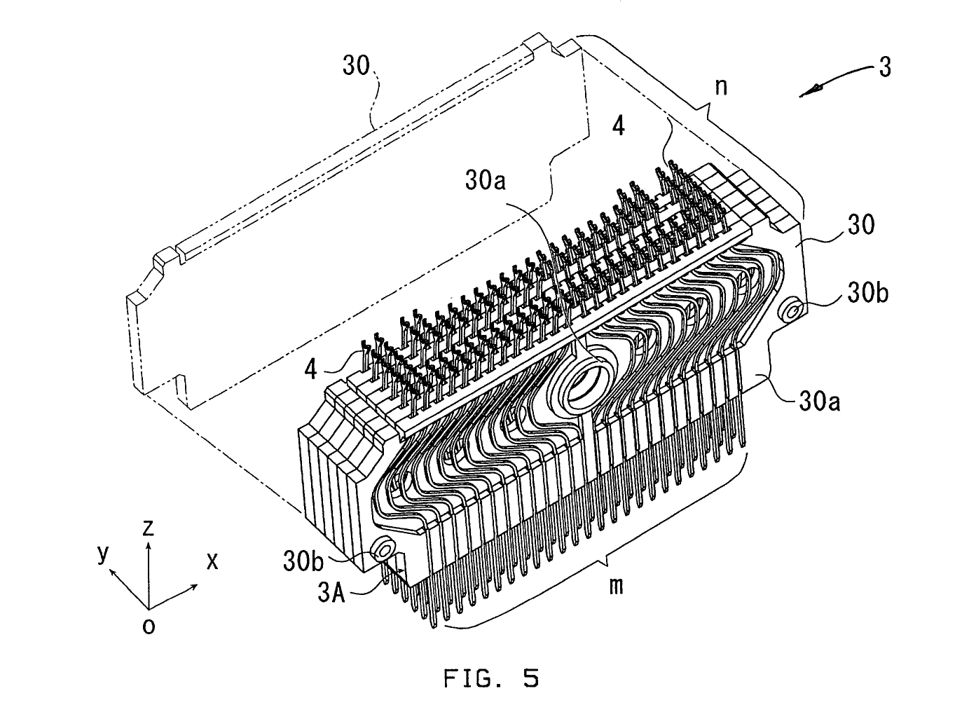

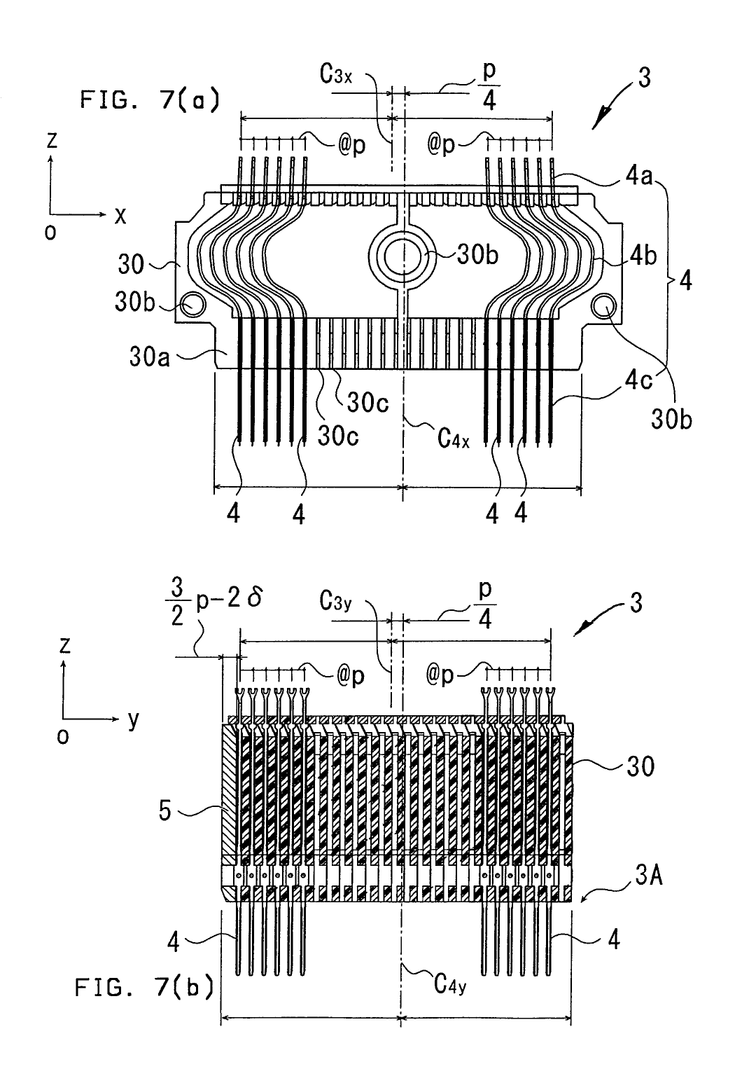

Each contact holder has a plurality of contact pins 4 mounted in it as is shown in FIGS. 5 and 7(a) and 7(b). Contact pin 4 has a bifurcated contact part 4a for connection with a terminal of an IC package, a curve shaped elastic central part 4b which is capable of being elastically deformed in conformity with the movement of contact part 4a, and a straight lead part 4c that extends downward from elastic central part 4b.

A first protrusion 4d is formed at the bottom portion of contact part 4a and a second protrusion 4e is formed at the start of lead part 4c. First and second protrusions 4d and 4e are formed like a plane in lined symmetry as compared with the center line of contact pin 4.

As is best shown in FIGS. 5 through 7, contact holder 30 has a thickness which is the same as the pitch p between terminals 10a of IC package 10 and has a generally rectangular shape. At the bottom of contact holder 30, an installation part 30a is provided of such prescribed shape to fit in an aperture 6 provided in the center of base 2.

On one surface of contact holder 30, a plurality of linking protrusions 30b are formed and, on the other surface of contact holder 30, a plurality of linking apertures (which are not shown in the drawings) are provided which are positioned and sized to receive linking protrusions 30b from adjacent contact holders 30. That is, one contact holder 30 is mutually linked/joined to other contact holders 30 by means of such linking protrusions and linking apertures.

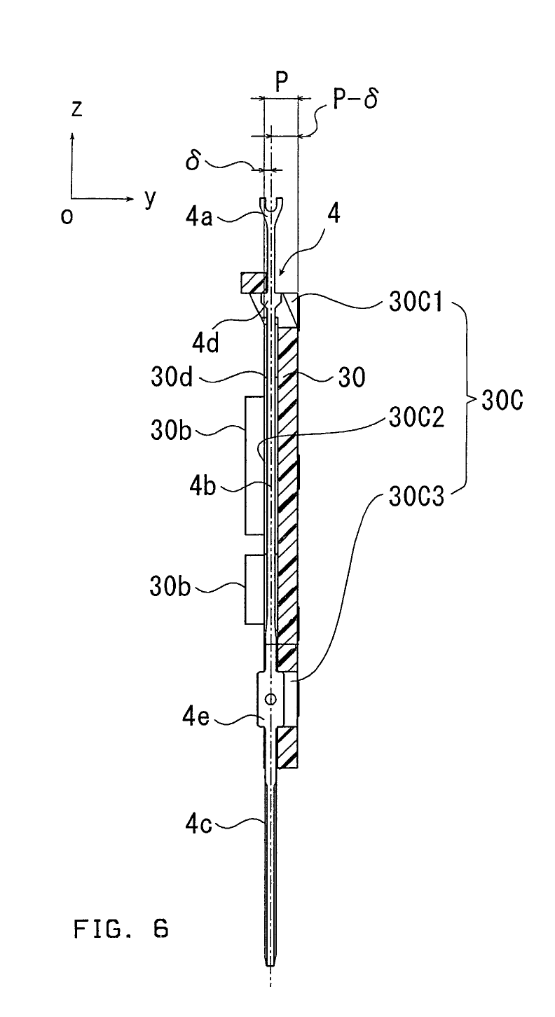

As is shown in FIG. 6, contact holder 30 has a holder part 30c that positions and holds a contact pin in the thickness direction (y axis direction) and this holder part 30c has a first holding part 30c1 that sandwiches first protrusion 4d of contact pin 4 thereby securing same, a guide channel 30c2 that houses the elastic part 4b of contact pin 4 in such a manner that it is capable of moving in both the x and z direction and an engagement opening 30c3 that fixedly holds the second protrusion 4e of contact pin 4.

As is shown in FIG. 7(a), contact holder 30 is for the purpose of positioning contact pins 4 in a longitudinal direction (x direction). A prescribed number m of holder parts 30c are provided for each pitch (p) between the terminals of IC package 10. As show in FIG. 5, moreover, contact holder unit 3 is formed by joining a prescribed number n of such contact holders together. That is, contact holder unit 3 has m lines by n rows of contact pins 4.

In the case of this embodiment, the arrangement of contact pins in the x direction C3x is shifted by ¼ pitch p in the minus x direction as compared with the standard center (center axis) C4x of installation part 30a of contact holder 30 as is shown in FIG. 7(a). Such an arrangement of contact pins will allow the loading into the socket of both an IC package of the odd-numbered matrix arrangement and the IC package of the even-numbered matrix arrangement.

Similarly, the center line of contact pins 4 is shifted by ¼ pitch p in the minus y direction as compared with the standard center line axis C4y of the contact holder unit 3. This results from the effect of linking protrusion 30b of contact holder 30 and spacer 5 as shown in FIGS. 6 and 7(b). That is, the standard center line of contact pin 4 is shifted by the amount of a deviation [symbol] in the plus y direction as compared with the surface 30b of contact holder 30 (which hereinafter will be referred to as the standard surface 30d) and a spacer 5 (see FIG. 7b) has a prescribed thickness of 3/2p-2 [symbol] .

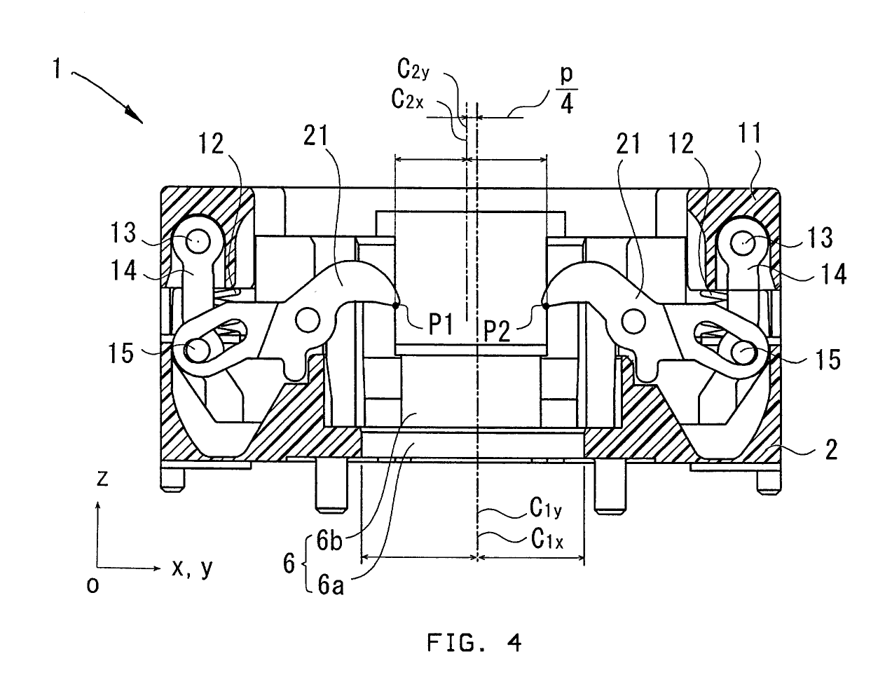

As is show in FIG. 4, contact holder unit 3 is fixed at the center of base 2.

A mounting aperture 6 with a step is formed in the base for the purpose of receiving holder unit 3 and allowing for lead parts 4c of contact pins 4 to protrude from the lower surface of the base 2.

A first mounting aperture portion 6a on the lower side of mounting aperture 6 has a cross-section in the form of a square size so as to perfectly fittingly receive installation linking body 3A of contact holder unit 3 in the y direction. A second mounting aperture portion 6b on the upper side of mounting aperture 6 has a square cross-section whose size is such that it will receive installation linking body 3A of contact holder 3 but with potentially space to spare.

The first fitting hole 6a is positioned in such a way that its center is aligned with center axis C1x and C1y of base 2.

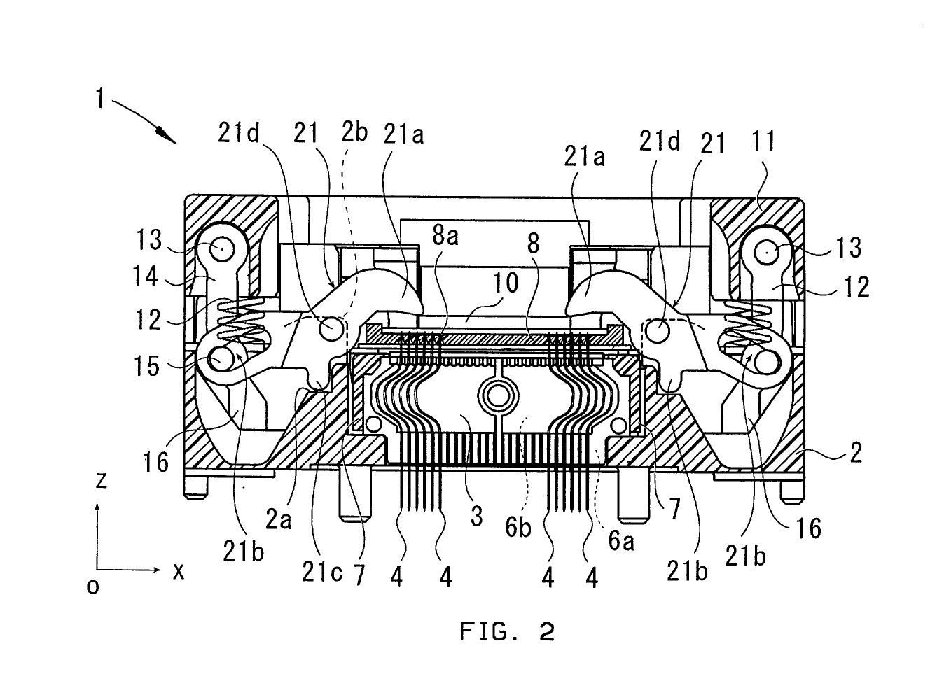

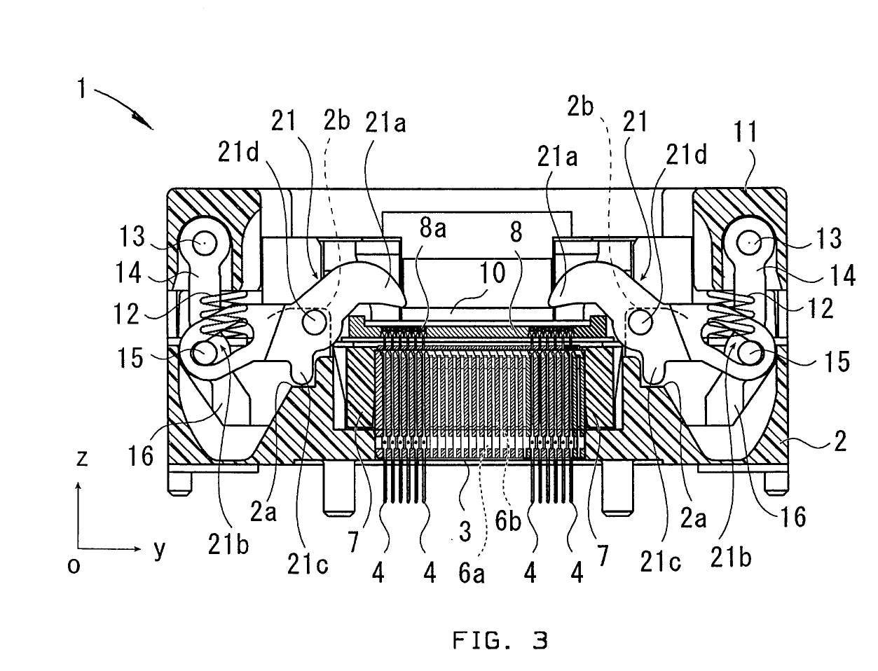

By causing the installation standard axis C4x and C4y of contact holder 3 to fit, the central standard axis C1x and C1y (center of the first mounting aperture 6a) or by causing same to rotate 180 degrees around the z axis form said state to fit the latter, the arrangement standard axis C3x shifts by ¼ pitch p as compared with central standard axis C1x of base 2. Likewise, the arrangement standard C3y in the y direction of the contact pin shifts by ¼ pitch p as compared with the central standard axis C1y of base 2. When contact holder 3 is to be inserted into first mounting aperture portion 6a and accordingly, secured to base 2 as is shown in FIG. 2 or 3, a spacer member 7 is used to fill vacant space in larger second mounting aperture portion 6b. An IC receiving part/adaptor 8 which is sized to receive IC package 10 is provided to be placed on top of contact holder unit 3.

Adaptor 8 has a plurality of contact holes 8a to correspond to the terminal leads of IC package 10 and the lines and rows of contact pins 4 to provide contacting between the leads and the pins. A contact part 4a of pin 4 is received inside each contact hole 8a.

As is shown in FIGS. 1 through 3, a cover 11 of the same general outer shape as base 2 is mounted on base 2. A coil spring 12 is mounted in the base at each corner between the base and cover to bias the cover in the up position and provide for the movement up and down of the cover relative to the base. At the center of cover 11 is an opening of such size to easily permit the passage of IC package 10 so that it can be placed on adaptor 8.

At each corner of cover 11, there is provided a link member 14 which is capable of moving with a fulcrum 13 as cover 11 moves up and down. An operating pin 15 is fixed to the bottom portion of each link member 14. This operating pin 15 moves down inside of base 2 contained by a guide groove 16 that is provided at each corner of base 2 as cover 11 moves downward.

Additionally, at each side of base 2, there is provided a latch or pressing member 21 for compressingly holding IC package 10 on adaptor 8. This latch has the general shape of a lever with a hook-shaped contact member 21a at one end for holding down IC package 10 and an oblong guide cam groove 21b at the other end for containing operating pin 15. At the middle part of latch 21, a protuberant support 21c is formed and a guide pin 21d is fixed thereto.

Support part 21c is restrained from movement in the x or the y direction by a first control part 2a that is provided in base 2. Further, guide pin 21d is restrained from movement in the z direction by a second control part 2b provided in base 2.

The operating pin 15 of link member 14 is contained in cam groove 21b. Accordingly, latch 21 moves with the movement of link member 14 as cover 11 moves vertically up and down. In the case where cover 11 is at its upper most position due to force from compressive coil springs 12, contact portion 21a of each latch 21 presses a respective peripheral end portion of the upper surface of the IC package 10 that has been placed on adaptor 8.

In accordance with this invention, latches 21 evenly press on an inserted IC package irrespective of whether such IC package is an odd-numbered matrix arrangement or an even-numbered matrix arrangement. That is, as shown in FIG. 4, the points of contact P1 and P2 where the two latches 21 in the x direction contact, the IC package 10 is shifted by only the ¼ pitch p in the x direction as compared to the central standard axis C1x of base 2 (C2x compared to C1x) and the points of contact P1 and P2 where the two latches in the y direction contact, the IC package 10 is shifted by only ¼ pitch p in the y direction as compared to the central standard axis C1y of base 2 (C2y compared to C1y).

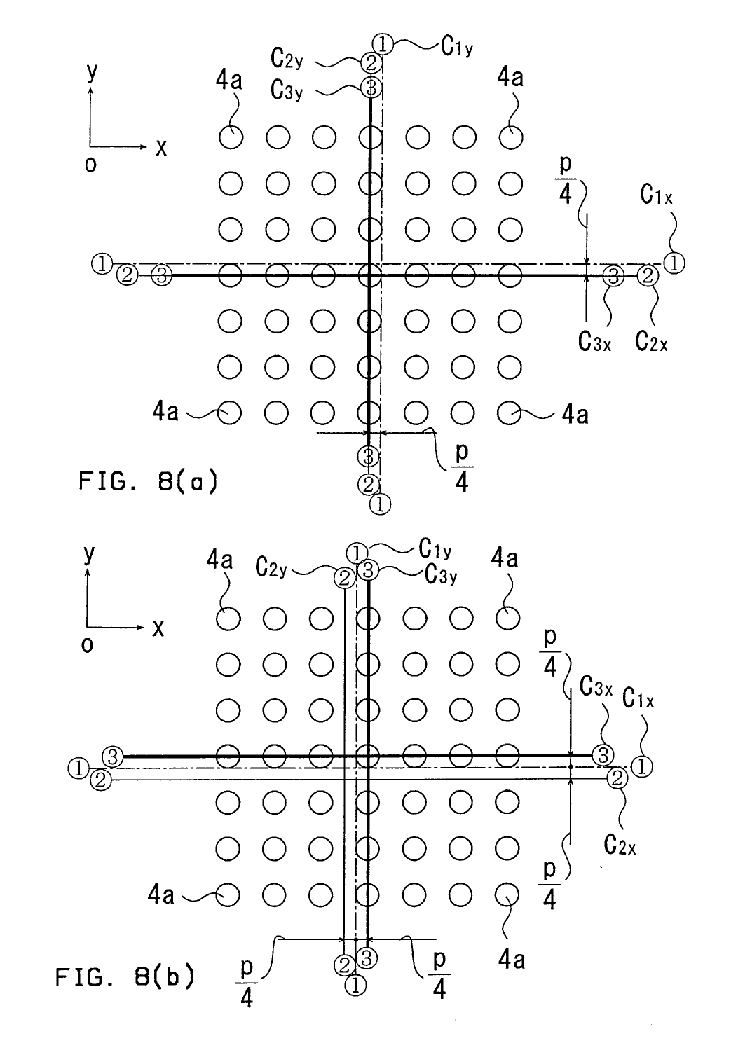

In the case where socket 1 is used to test an IC package 10 of the odd-numbered matrix structure, contact holder unit 3 is mounted on base 2 with the linkage protrusion 30b side as the front as is shown in FIG. 2 or in FIG. 3. In this case, the arrangement of the contact pins 4 is set in an odd-numbered matrix arrangement as is shown in FIG. 8(a). The arrangement axis C3x and C3y for contact pins are shifted by a minus ¼ pitch p as compared with the central axis C1x and C1y respectively of base 2. Additionally, the axis C2x and C2y for the latches are also shifted by a minus ¼ pitch p as compared with the central axis C1x and C1y respectively of base 2. Thus, the arrangement axis C3x and C3y for the contact pins 4 are aligned with the compression axis C2x and C2y for the latches 21 respectively.

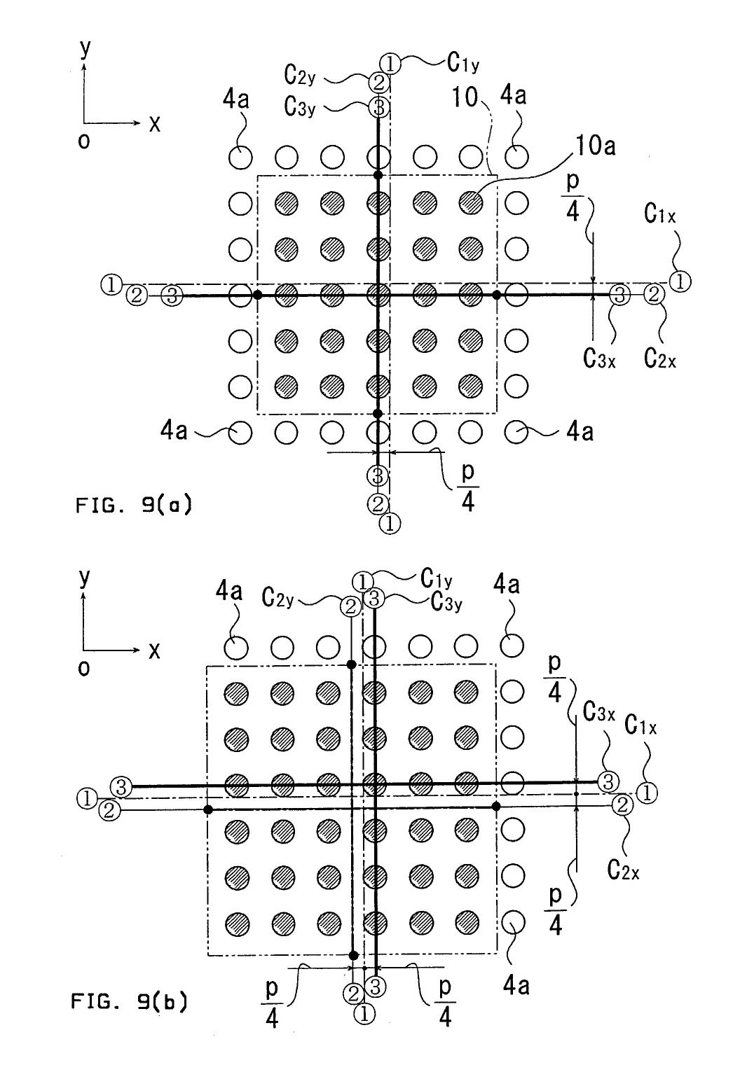

Accordingly, where the IC package 10 is set on the odd-numbered matrix arrangement of contact pins 4 so that the center lines in the x and y directions of the IC package 10 of the odd-numbered matrix terminal structure are aligned with the arrangement standards C3x and C3y of the contact pins 4 as is shown in FIG. 9(a), the center lines in the x and y directions of IC package 10 are aligned with compression axis for the latches where each terminal 10a of the IC package 10 is in contact with contact part 4a of contact pin 4.

On the other hand, in the case where socket 1 is made to correspond to an IC package 10 of an even-numbered matrix structure, the contact holder unit 3 is rotated 180 degrees around the z axis from the state described above and shown in FIG. 2. Thus, the arrangement of contact pins 4 is set in the even-numbered matrix arrangement as is shown in FIG. 8(b).

In this case, the arrangement axis C3x and C3y of contact pins 4 are shifted by a positive ¼ pitch p respectively. Correspondingly, the axis C2x and C2y of latches 21 are shifted by a minus ¼ pitch p as compared with the central axis C1x and C1y of base 2. This results in the structure where C3x and C3y of contact pins 4 are shifted by ½ pitch p as compared with C2x and C2y for latches 21 respectively.

Accordingly, when the IC package 10 is placed on the even-numbered matrix arrangement of contact pins 4 so that each segment of the line has been shifted by a positive ½ pitch p from the center line in the x and y direction of the IC package are aligned with the arrangement C3x and 3cy of contact pins 4 as is shown in FIG. 9(b), the center line in the x and y directions of the IC package 10 are aligned with C2x and C2y for latches 21 in a state where each terminal 10a of IC package 10 is in contact with a touch part 4a of a contact pin 4.

In accordance with this embodiment of this invention, contact holders 30 that hold a prescribed number of pins 4 in a single direction are joined together to form a contact unit 3. It is only necessary to design molds and produce parts that hold one row of contact pins 4. Accordingly, it becomes easily possible to manufacture a contact holder that holds a large number of contact pins. Additionally, the contact unit 3 incorporating a prescribed number of contact holders 30 can be designed easily to handle various terminal arrangements of an IC package. It then becomes possible for one kind of socket to take care of various IC packages of the same pitch but different terminal arrangements.

In accordance with this invention, it becomes possible to let one socket base design handle various IC packages having different pitches by preparing several kinds of contact holders 30 having common shapes and sizes of the installation part 30a and several kinds of adaptors 8 in conformity with the sizes of the pitches of the IC packages to be tested. In connection with several kinds of socket 1, it becomes possible to employ a common base 2.

In accordance with this invention, the compression axis for the latches 21 has been shifted by ¼ pitch p as compared with the central standard axis C1 of the base and the installation axis C4 of contact holder unit 3 is aligned with the central standard axis C1 of base 2, followed by the shifting of the arrangement axis C3 for contact pins 4 by ¼ pitch p as compared to the installation axis C4. By merely changing the state of the mounting of contact holder unit 3 on base 2, it becomes possible to set the arrangement of contact pins 4 either on the odd-numbered matrix arrangement or the even-numbered matrix arrangement. Accordingly, it becomes possible to realize uniform contacting compression for IC packages by using one kind of socket irrespective of whether the IC package is of the odd-numbered matrix terminal structure or the even-numbered matrix terminal structure.

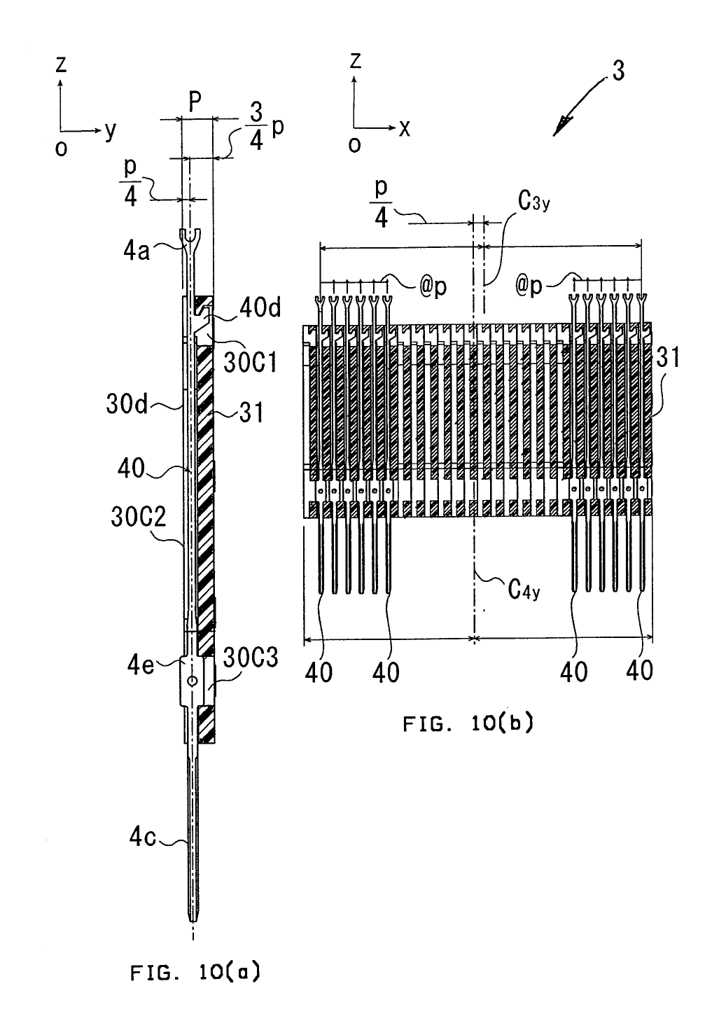

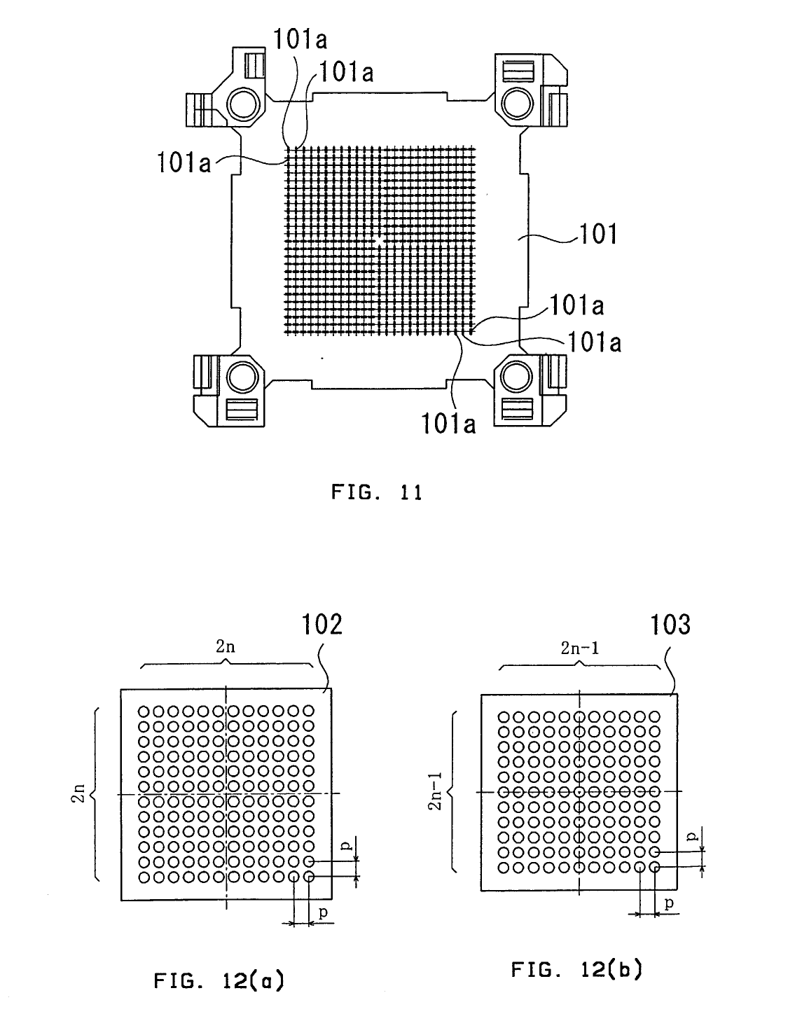

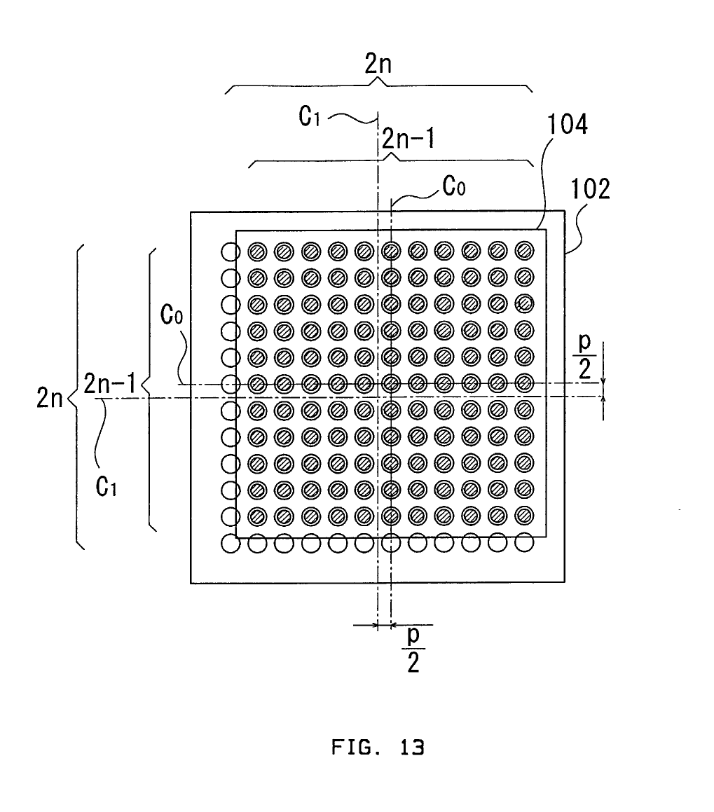

FIGS. 10(a) and 10(b) show a second embodiment of the present invention. As is shown in FIG. 10(a) a contact pin 40 is employed with a structure which is approximately the same as the form shown in the embodiment above for contact pin 4. However, there is a difference in that a first protrusion part 40d does not protrude in the minus y direction. Along with this, a holding part 31c1 of contact holder 31 is formed in such a way as not to protrude in the minus y direction.

According to this embodiment, it becomes possible to shift the arrangement axis C3y in the y direction of the contact pin 40 by ¼ pitch p as compared to the installation axis C4y of the contact holder unit 3 by merely joining this contact holder 31 in the y direction as shown in the FIG. 10(b).

This invention has been described with reference to specific embodiments; however, it is intended to embrace all such alternative modifications and variations as fall within the spirit and scope of the appended claims. For example, the socket of this invention works equally well where the terminal arrangement of the IC package is an even number (x direction) and an odd number (y direction) or an odd number (x direction) and an even number (y direction).

In the case of the IC package that has a terminal arrangement of an even number (x direction) and an odd number (y direction) which is obtained by adding a terminal row in the y direction to the IC package 10 of an odd number (x direction), and an odd number (y direction) as shown in FIG. 9(a), the central line shifts by a ½ pitch p in the x direction. By rotating the contact holder unit 3 by 90 degrees around the z axis from the state shown at the front (the state where the arrangement of the contact pin 4 is in an odd-numbered matrix arrangement), thereby shifting only the arrangement standard C3y regarding the y direction of the contact pin 4 by a ½ pitch p portion in the y direction, therefore, it becomes possible to align the central line of the IC package of an even number (x direction) and an odd number (y direction) with the compression axis C2 for the latches 21.

It becomes similarly possible to cope with the IC package having a terminal arrangement of an odd number (x direction) and an even number (y direction) by rotating the contact holder unit 3 by 90 degrees.

Further, it becomes possible to let one kind of socket take care of those IC packages that have a terminal arrangement of an even number (x direction) and an odd number (y direction) or a terminal arrangement of an odd number (x direction) and an even number (y direction) by adjusting the deviation (delta) in the standard of the contact pin 4 or in the thickness of the spacer 5 and shifting the arrangement standard C3 of the contact pin in one direction alone by a ¼ pitch p as compared with the installation standard C4.

In the embodiments mentioned above, the contact holder holds one row of the contacts. However, it is possible to adopt a constitution where a plurality of rows of contacts are held such as two rows or three rows.

In the embodiments shown above, a socket for mounting the IC package and the BGA package has been shown. However, the socket according to this invention can also be used for the LGA (land grid array) package that has a flat terminal without providing a solder ball. It should be pointed out, however, that in such a case, the shape of the contact part of the contact pin 4 will have to be changed to a flat one.

In the embodiments shown above, a socket shown is of such a type that the touch part 4a of the contact pin 4 is touched in the perpendicular direction as compared with the terminal of the IC package. However, it becomes possible to use the contact holder unit 3 according to this invention for the sockets of the type where the contact part of the contact pin is caused to contact the solder ball of the BGA package by holding it from the horizontal direction by using a sliding member and a contact pin that has a bifurcated touch part.

We claim:

1. A socket for mounting an electric part with a plurality of connective terminals comprising a base having a top surface and a bottom surface and a central aperture, a cover mounted on said base so as to be able to move back and forth from a first position away from the top surface of the base to a second position adjacent the top surface of the base, a spring member to bias said cover away from said base, a holding member that accurately holds a plurality of contact members for making contact with said plurality of connective terminals of said electric part, said plurality of contact members are mounted in the holding member in the shape of a matrix and said holding member is secured to said base in the central aperture, an electronic part receiving part for mounting the electronic part in the socket having a plurality of through holes that correspond to said plurality of contact members, said electronic part receiving part being placed adjacent the top surface of said base member overlying said holding member, and a pressing member mounted in said base so as to be able to revolve on said base in conjunction with said cover moving back and forth from a first original position directly adjacent said part receiving part to a second position away from said part receiving part thereby making it possible to mount said electric part in the second position and compressively securing the electronic part in the first original position, where said holding member comprises a plurality of holding parts that hold at least one row of contact members to form the matrix of contact makers and said contact member comprises a base part that is fixed to said holding part, a curved central part capable of elastic deformation within said holding member and a top contact part for being compressively contacted by a connective terminal of the electric part.

2. A socket according to claim 1 wherein said holding part holds one row of contact members and has a thickness equal to the pitch between neighboring contact members.

3. A socket according to claim 1 wherein said holding member can be installed in the central aperture of the base in more than one orientation position.

4. A socket according to claim 3 wherein said more than one orientation position is two orientation positions with the arrangement of the plurality of contact members arranged in the shape of a matrix having a row direction and a line direction in which the second orientation position is shifted either in the row direction or the line direction by one half of the pitch between neighboring contact members as compared to the first orientation position.

5. A socket according to claim 4 wherein said holding member is rotated in the base by 90 degrees in said second orientation position as compared to the first orientation position.

6. A socket according to claim 4, wherein said holding member is rotated by 180 degrees as compared to the first orientation position.

7. A socket according to claim 1 further including a spacer member associated with the central aperture in the base.

8. A socket according to claim 1 wherein pressing member has four portions with each portion positioned so as to be able to engage one of the four top peripheral side surface portions of said electric part when in the first original position.

9. A socket according to claim 8 wherein a center axis in the x and y direction, as viewed from the top of the socket, for the base is shifted one quarter of the pitch between neighboring contact members as compared with a center axis in the x and y direction, as viewed from the top of the socket, for the matrix of the contact members and a center axis in the x and y direction, as viewed from the top of the socket, for the pressing member.
